(19) United States
(12) Patent Application Publication
(10) Pub. No.: US 2019/0042133 A1
(43) Pub. Date: Feb. 7, 2019

(54) TECHNOLOGIES FOR PROVIDING ADAPTIVE DATA ACCESS REQUEST ROUTING IN A DISTRIBUTED STORAGE SYSTEM

(71) Applicant: Intel Corporation, Santa Clara, CA (US)

(72) Inventors: Scott Peterson, Beaverton, OR (US); Sujoy Sen, Beaverton, OR (US)

(21) Appl. No.: 16/023,025

(22) Filed: Jun. 29, 2018

(51) Int. Cl. G06F 3/06; H04L 29/08

(52) U.S. Cl. CPC G06F 3/0635; H04L 67/2814; G06F 3/067; G06F 3/0614; H04L 67/32

(57) ABSTRACT

Technologies for providing adaptive data access request routing in a distributed storage system include a compute device. The compute device includes a redirector device to receive, from an initiator device, a request that identifies a data set to be accessed. The redirector device is also to determine, from a set of routing rules indicative of target devices associated with data sets, whether the identified data set is available in a storage server associated with the present redirector device, forward, in response to a determination that the identified data set is not available in a storage server associated with the present redirector device, the request to a target device associated with the data set in the routing rules, and send, to the initiator device, an identification of the target device associated with the data set in the routing rules. Other embodiments are also described and claimed.

### BACKGROUND

Conventional distributed block storage systems provide block device functionality to applications based on pools of remote storage devices. In such systems, a compute device that provides access to data sets (e.g., sections of a volume, also sometimes referred to as extents, that may be distributed across multiple storage devices in multiple storage servers) references a map or other data structure (e.g., in memory) that indicates the precise location of each data set to be accessed. In a typical data center (e.g., a cloud data center), storage devices may remain in operation for a predefined period of time and then be decommissioned or repurposed (e.g., from a pool that maintains frequently accessed data sets to a pool that maintains less frequently accessed data sets). Accordingly, the mapping of data sets to the associated storage devices in the data center may change on an ongoing basis. As such, if a map utilized by a compute device in the data center to determine the locations of each data set becomes outdated or otherwise incorrect (e.g., because a data set has moved), the distributed storage system may encounter errors, such as an inability to read from or write to a particular data set.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified diagram of at least one embodiment of a system for providing adaptive data access request routing for distributed storage;

FIG. 2 is a simplified block diagram of at least one embodiment of a compute device included in the system of FIG. 1; and

FIGS. 3-5 are a simplified block diagram of at least one embodiment of a method for providing adaptive data access request routing that may be performed with a redirector device of a compute device of FIGS. 1 and 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

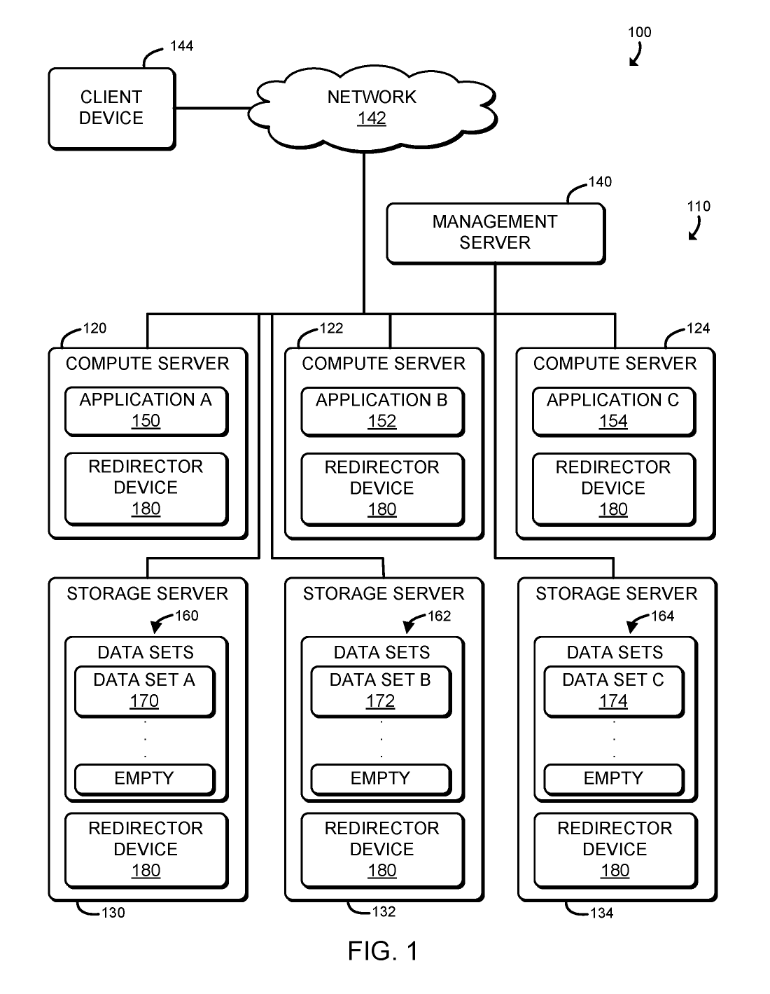

Referring now to FIG. 1, a system 100 for providing adaptive data access request routing for distributed storage includes a set of compute devices 110 including compute servers 120, 122, 124 and storage servers 130, 132, 134. In the illustrative embodiment, the compute servers 120, 122, 124 and the storage servers 130, 132, 134 are in communication with a management server 140, which, in operation, may assign applications (e.g., processes, sets of operations, etc.) 150, 152, 154 to the compute servers 120, 122, 124 to execute on behalf of a client device 144. During execution, an application (e.g., the application 150) may request access to a data set 160, 162, 164, 170, 172, 174 that is available in one or more copies (e.g., replicas) in one or more of the storage servers 130, 132, 134. In the illustrative embodiment, each compute device 110 includes a redirector device 180, which may be embodied as any device or circuitry (e.g., a co-processor, an application specific integrated circuit (ASIC), etc.) configured to identify, from a set of routing rules, a target device (e.g., a storage server, another redirector device, etc.), where the request to access a particular data set is to be sent.

Initially, each redirector device 180 may store a set of default routing rules (e.g., provided by the management server 140, a configuration file, or another source) that may not precisely identify the location of each data set and instead, provides general direction as to where requests should be sent. However, over time (e.g., as data access requests are communicated through the system 100) the redirector devices 180 in the system 100 share information (e.g., hints) as to the precise locations of the data sets and thereby reduce the number of hops (e.g., rerouting of data access requests among the redirector devices 180) to enable requests to be sent more directly to the precise locations (e.g., the storage server 130, 132, 134 that actually stores a particular data set). In particular, if a redirector device 180 receives a data access request and determines (e.g., from a set of routing rules utilized by that redirector device 180) that the data access request should be sent to another target device (e.g., a redirector device 180 in a storage server 132 that actually stores the requested data set), the redirector device 180 forwards request to the other target device (the “downstream target device”). Further, the present redirector device 180 sends the identity of the downstream target device (e.g., the target device to which the request is to be forwarded) upstream to the initiator device (e.g., the device that sent the data access request to the present redirector device 180) for future reference. Furthermore, as data sets are moved between storage servers 130, 132, 134, the redirector devices 180 propagate updates to their routing rules using the scheme described above. As such, by automatically propagating updates to the locations of the data sets among redirector devices 180, the system 100 provides greater reliability over typical distributed storage systems in which changes to the locations of data sets can result in failures to access the data sets.

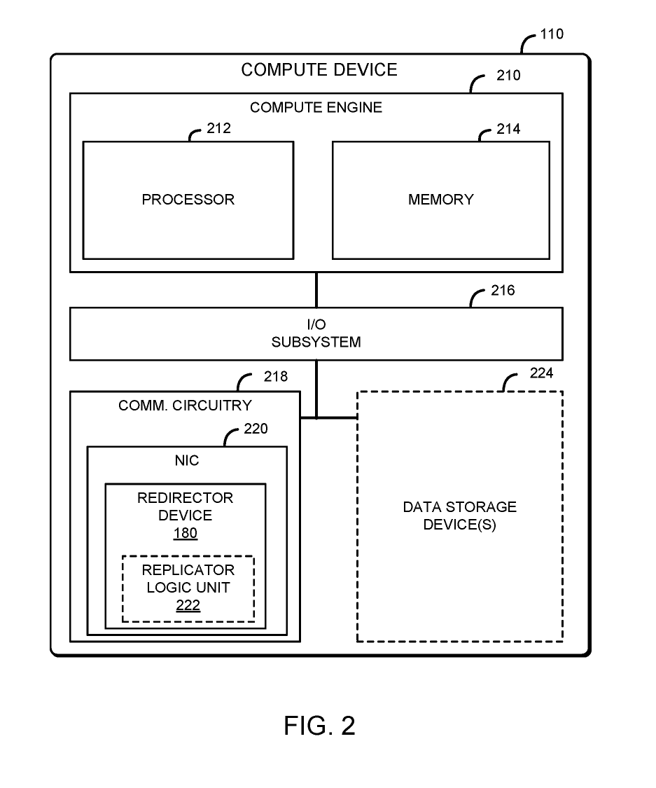

Referring now to FIG. 2, the illustrative compute device 110 (e.g., a compute server 120, 122, 124, a storage server 130, 132, 134, etc.) includes a compute engine (also referred to herein as “compute engine circuitry”) 210, an input/output (I/O) subsystem 216, communication circuitry 218, and may include (e.g., in the case of a storage server) one or more data storage devices 224. Of course, in other embodiments, the compute device 110 may include other or additional components, such as those commonly found in a computer (e.g., a display, peripheral devices, etc.). Additionally, in some embodiments, one or more of the illustrative components may be incorporated in, or otherwise form a portion of, another component. Further, in some embodiments, one or more of the components may be any distance away from another component of the compute device 110 (e.g., distributed across a data center). The compute engine 210 may be embodied as any type of device or collection of devices capable of performing various compute functions described below. In some embodiments, the compute engine 210 may be embodied as a single device such as an integrated circuit, an embedded system, a field-programmable gate array (FPGA), a system-on-a-chip (SOC), or other integrated system or device. In the illustrative embodiment, the compute engine 210 includes or is embodied as a processor 212 and a memory 214. The processor 212 may be embodied as any type of processor capable of performing the functions described herein. For example, the processor 212 may be embodied as a multi-core processor(s), a microcontroller, or other processor or processing/controlling circuit. In some embodiments, the processor 212 may be embodied as, include, or be coupled to an FPGA, an application specific integrated circuit (ASIC), reconfigurable hardware or hardware circuitry, or other specialized hardware to facilitate performance of the functions described herein.

The main memory 214 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as dynamic random access memory (DRAM) or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces.

In one embodiment, the memory device is a block addressable memory device, such as those based on NAND or NOR technologies. A memory device may also include a three dimensional crosspoint memory device (e.g., Intel 3D XPoint™ memory), or other byte addressable write-in-place nonvolatile memory devices. In one embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the die itself and/or to a packaged memory product.

In some embodiments, 3D crosspoint memory (e.g., Intel 3D XPoint™ memory) may comprise a transistor-less stackable cross point architecture in which memory cells sit at the intersection of word lines and bit lines and are individually addressable and in which bit storage is based on a change in bulk resistance. In some embodiments, all or a portion of the main memory 214 may be integrated into the processor 212. In operation, the main memory 214 may store various software and data used during operation such as applications, data operated on by the applications, routing rules, libraries, and drivers.

The compute engine 210 is communicatively coupled to other components of the compute device 110 via the I/O subsystem 216, which may be embodied as circuitry and/or components to facilitate input/output operations with the compute engine 210 (e.g., with the processor 212 and/or the main memory 214) and other components of the compute device 110. For example, the I/O subsystem 216 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 216 may form a portion of a system-on-a-chip (SoC) and be incorporated, along with one or more of the processor 212, the main memory 214, and other components of the compute device 110, into the compute engine 210.

The communication circuitry 218 may be embodied as any communication circuit, device, or collection thereof, capable of enabling communications over the network 142 between the compute device 110 and another compute device (e.g., a compute server 120, 122, 124, a storage server 130, 132, 134, the management server 140, the client device 144, such as to provide a fast path between the client device 144 and the redirector device 180, etc.). The communication circuitry 218 may be configured to use any one or more communication technology (e.g., wired or wireless communications) and associated protocols (e.g., Ethernet, Bluetooth®, Wi-Fi®, WiMAX, etc.) to effect such communication.

The illustrative communication circuitry 218 includes a network interface controller (NIC) 220, which may also be referred to as a host fabric interface (HFI). The NIC 220 may be embodied as one or more add-in-boards, daughter cards, network interface cards, controller chips, chipsets, or other devices that may be used by the compute device 110 to connect with another compute device (e.g., a compute server 120, 122, 124, a storage server 130, 132, 134, the management server 140, the client device 144, etc.). In some embodiments, the NIC 220 may be embodied as part of a system-on-a-chip (SoC) that includes one or more processors, or included on a multichip package that also contains one or more processors. In some embodiments, the NIC 220 may include a local processor (not shown) and/or a local memory (not shown) that are both local to the NIC 220. In such embodiments, the local processor of the NIC 220 may be capable of performing one or more of the functions of the compute engine 210 described herein. Additionally or alternatively, in such embodiments, the local memory of the NIC 220 may be integrated into one or more components of the compute device 110 at the board level, socket level, chip level, and/or other levels. In the illustrative embodiment, the NIC 220 includes the redirector device 180 described above with reference to FIG. 1. Further, the redirector device 180 may include a replicator logic unit 222, which may be embodied as any device or circuitry (e.g., a co-processor, an FPGA, an ASIC, etc.) configured to manage the replication (e.g., copying) of data sets among multiple data storage devices 224 (e.g., across multiple storage servers 130, 132, 134), including forwarding write requests to multiple downstream target devices (e.g., to other storage servers), detecting overlapping write requests (e.g., requests to write to the same logical block address (LBA)), coordinating application writes with replica resilvering, and ensuring that writes to the replicas are performed in a predefined order (i.e., the order in which the write requests were produced). In some embodiments of the system 100, one or more of the redirectors devices 180 may be a standalone device (e.g., located between the compute devices 110 rather than incorporated into a compute device 110).

The one or more illustrative data storage devices 224 may be embodied as any type of devices configured for short-term or long-term storage of data such as, for example, memory devices and circuits, memory cards, hard disk drives, solid-state drives, or other data storage devices. Each data storage device 224 may include a system partition that stores data and firmware code for the data storage device 224. Each data storage device 224 may also include one or more operating system partitions that store data files and executables for operating systems. In embodiments in which the compute device 110 is a storage server 130, 132, 134, the data storage devices 224 store one or more of the data sets 160, 162, 164.

The management server 140 and the client device 144 may have components similar to those described in FIG. 2 with reference to the compute device 110. The description of those components of the compute device 110 is equally applicable to the description of components of the management server 140 and the client device 144, with the exception that, in some embodiments, the redirector device 180 and the replicator logic unit 222 is not included in the communication circuitry of the management server 140 and/or the client device 144. Further, it should be appreciated that any of the compute devices 110, the management server 140, and the client device 144 may include other components, sub-components, and devices commonly found in a computing device, which are not discussed above in reference to the compute device 110 and not discussed herein for clarity of the description.

As described above, the compute servers 120, 122, 124, the storage servers 130, 132, 134, the management server 140, and the client device 144 are illustratively in communication via the network 142, which may be embodied as any type of wired or wireless communication network, including global networks (e.g., the Internet), local area networks (LANs) or wide area networks (WANs), cellular networks (e.g., Global System for Mobile Communications (GSM), 3G, Long Term Evolution (LTE), Worldwide Interoperability for Microwave Access (WiMAX), etc.), a radio area network (RAN), digital subscriber line (DSL) networks, cable networks (e.g., coaxial networks, fiber networks, etc.), or any combination thereof.

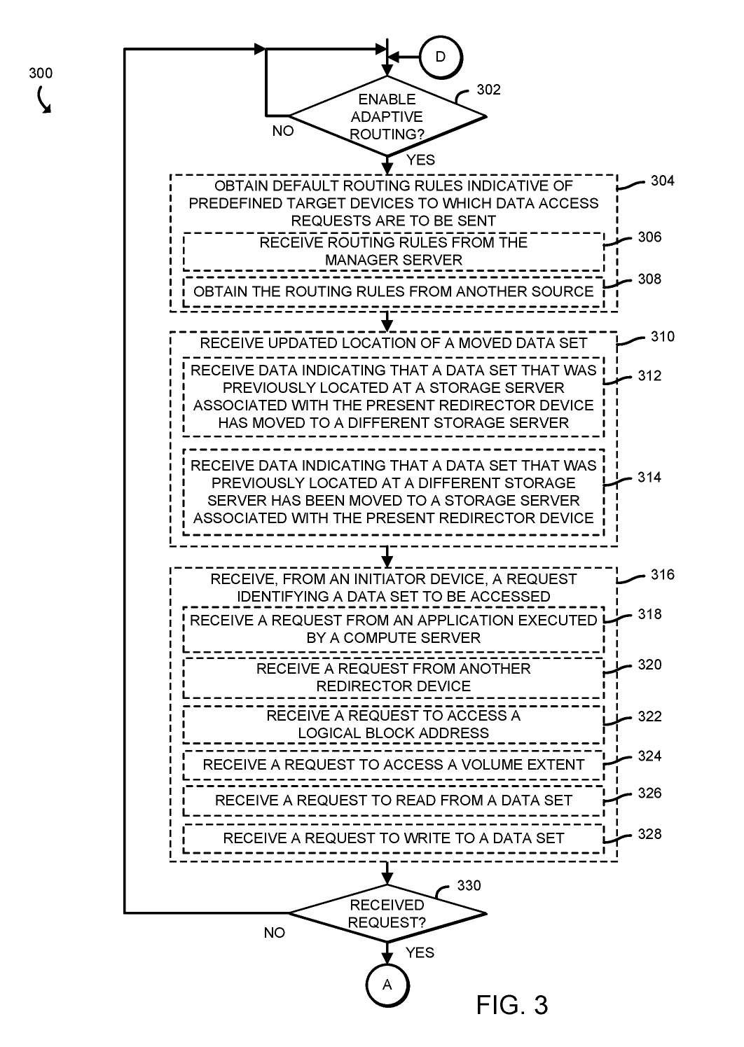

Referring now to FIG. 3, a redirector device 180, in operation, may execute, a method 300 for providing adaptive data access request routing. The method 300 begins with block 302, in which the redirector device 180 determines whether to enable adaptive routing of data access requests. In the illustrative embodiment, the redirector device 180 may determine to enable adaptive routing in response to performing a self-diagnostic and determining that the self-diagnostic has not detected any errors, in response to determining that other redirector devices 180 are present in the system 100, and/or based on other factors. Regardless, in response to a determination to enable adaptive routing, the method 300 advances to block 304 in which the redirector device 180 may obtain default routing rules indicative of predefined target devices to which data access requests are to be sent. In doing so, and as indicated in block 306, the redirector device 180 may receive the routing rules from the management server 140 (e.g., through the network 142). Alternatively, and as indicated in block 308, the redirector device 180 may obtain the routing rules from another source, such as from a configuration file (e.g., present in a data storage device 224 or in the memory 214).

Subsequently, in block 310, the redirector device 180 may receive data (e.g., routing rules) indicative of an updated location of a data set that has been moved. In doing so, and as indicated in block 312, the redirector device 180 may receive data indicating that a data set that was previously located at a storage server (e.g., the storage server 130) associated with the present redirector device 180 (e.g., the redirector device 180 used to perform the method 300 is a component of the storage server 130) has moved to a different storage server (e.g., the storage server 132). Alternatively, as indicated in block 314, the redirector device 180 may receive data indicating that a data set that was previously located at a different storage server 134 has been moved to a storage server (e.g., the storage server 130) associated with the present redirector device 180 (e.g., the redirector device 180 performing the method 300 is a component of the storage server 130).

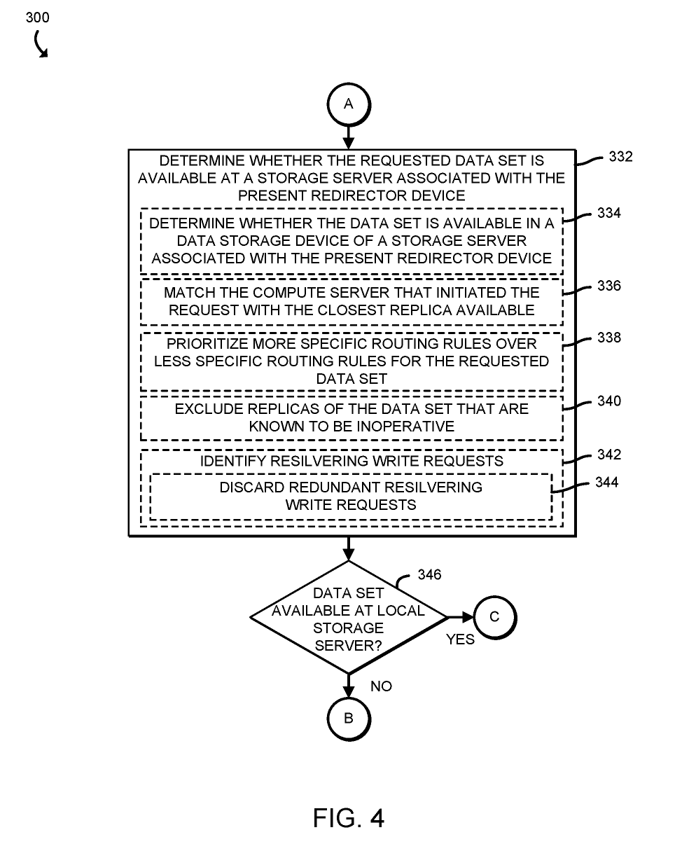

As indicated in block 316, the redirector device 180 receives, from an initiator device, a request that identifies a data set to be accessed. In doing so, and as indicated in block 318, the redirector device 180 may receive the request from an application executed by a compute server (e.g., from the compute engine 210) executing an application (e.g., the application 150). As indicated in block 320, the redirector device 180 may receive the request from another redirector device 180 (e.g., a redirector device included in another compute device 110). Additionally, as indicated in block 322, in receiving the request, the redirector device 180 may receive a request to access a specified logical block address (LBA). As indicated in block 324, the request may be to access an extent (e.g., a defined section) of a volume. The request may be a request to read from a data set, as indicated in block 326, or to write to a data set, as indicated in block 328. In block 330, the redirector device 180 determines the subsequent course of action as a function of whether a request was received in block 316. If no request was received, the method 300 loops back to block 302, in which the redirector device 180 determines whether to continue to enable adaptive routing. Otherwise (e.g., if a request was received), the method 300 advances to block 332 of FIG. 4, in which the redirector device 180 determines whether the requested data set is available at a storage server associated with the present redirector device 180 (e.g., whether the redirector device 180 is a component of the storage server 130 on which the requested data set is stored).

Referring now to FIG. 4, as indicated in block 334, the redirector device 180 in determining whether the requested data set is available on the storage server 130, determines whether the data set is available in a data storage device 224 of the storage server 130. Further, in determining whether the requested data set is available at a storage server associated with the present redirector device 180, the redirector device 180 may additionally match an identity of the compute server 120 that initiated the request (e.g., a read request) with a replica of the data set that is closest (e.g., in the same physical rack rather than in another rack of the data center) to the compute server 120, as indicated in block 336. If the redirector device 180 is not associated with (e.g., not a component of) the storage server having the closest replica of the data set for the compute server 120 that initiated the request, the redirector device 180 may determine that the requested data set is not available at the present storage server 130, even if the data set actually is stored in the present storage server 130.

As indicated in block 338, the redirector device 180 may prioritize more specific routing rules over less specific routing rules for the requested data set. For example, the routing rules may include one rule that indicates that requests associated with a particular range of logical block addresses or requests associated with a particular volume should generally be routed to the redirector device 180 in the storage server 132, while another routing rule specifies that requests to access a specific logical block address within that broader range, or a particular extent of the volume, should be sent to the storage server 134. In the above scenario, the redirector device 180 selects the second routing rule, as it is more specific and will provide a more direct route to the actual location of the requested data set. As indicated in block 340, the redirector device 180, in the illustrative embodiment, excludes from the selection of a target device (e.g., a storage server 130, 132, 134), any target device having a replica that is known to be inoperative (e.g., the data storage device 224 on which the replica is stored is malfunctioning). The redirector device 180 may receive data regarding the operational status of an inoperative replica from the storage server 130, 132, 134 on which the replica is hosted (e.g., stored), from the management server 140, or from another source (e.g., from another redirector device 180).

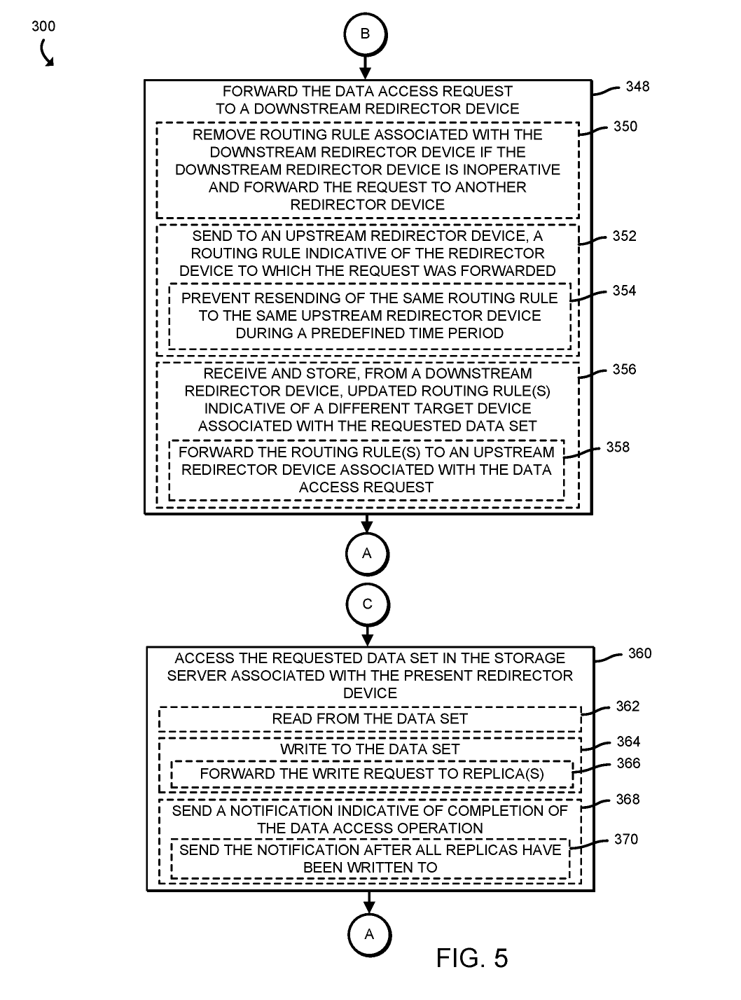

As indicated in block 342, the redirector device 180 may identify resilvering write requests (e.g., requests to write data to a replica that in the process of being created). In doing so, and as indicated in block 344, the redirector device 180 discards any redundant resilvering write requests (e.g., requests to write to the same logical block address). Subsequently, in block 346, the redirector device 180 determines the subsequent course of action based on whether the requested data set has been determined to be available at a local storage server (e.g., a storage server 130 that the redirector device 180 is a component of). If not, the method 300 advances to block 348 of FIG. 5, in which the redirector device 180 forwards the data access request to a downstream redirector device 180. Otherwise, the method 300 advances to block 360 of FIG. 5, in which the redirector device 180 accesses the requested data set in the storage server associated with the present redirector device 180.

Referring now to FIG. 5, in forwarding the data access request to a downstream redirector device 180, the present redirector device 180 may remove (e.g., delete) a routing rule associated with a downstream redirector device 180 if that downstream redirector device 180 is inoperative (e.g., unresponsive) and forward the data access request to another redirector device 180, as indicated in block 350. As indicated in block 352, the redirector device 180 may send, to an upstream redirector device 180 (e.g., a redirector device 180 that sent the request to the present redirector device 180), a routing rule indicative of the downstream redirector device 180 to which the request was forwarded. In doing so, however, the redirector device 180 may suppress (e.g., prevent the resending of) a routing rule that was previously sent to the same upstream redirector device within a predefined time period (e.g., within the last 5 minutes), as indicated in block 354. As indicated in block 356, the redirector device 180 may receive and store, from a downstream redirector device 180, one or more updated routing rules indicative of a different target device associated with the requested data set (e.g., a different storage server 130, 132, 134 or redirector device 180 to which data access requests associated with the data set should be sent in the future). Further, and as indicated in block 358, the redirector device 180, in the illustrative embodiment, may forward the routing rule(s) to an upstream redirector device 180 associated with the data access request (e.g., that sent the data access request to the present redirector device 180). Subsequently, the method 300 loops back to block 302 of FIG. 3, in which the redirector device 180 determines whether to continue to enable adaptive routing of data access requests.

Still referring to FIG. 5, if the method 300 instead advanced to block 360 in which the redirector device 180 accesses the requested data set in the storage server 130 associated with the present redirector device 180, the redirector device 180 may read from the data set, as indicated in block 362, or may write to the data set, as indicated in block 364. In writing to the data set, the redirector device 180 may forward the write requests to one or more other storage servers (e.g., through one or more redirector devices 180) to write the same data to corresponding replicas hosted on those storage servers. As indicated in block 368, the redirector device 180 may send a notification (e.g., to an upstream device) indicating completion of the data access operation (e.g., read or write). In the case of a write, and as indicated in block 370, the redirector device 180 waits until all replicas have successfully been written to before sending the notification of completion. Subsequently, the method 300 loops back to block 302 of FIG. 3, in which the redirector device 180 determines whether to continue to enable adaptive routing of data access requests.

### EXAMPLES

Illustrative examples of the technologies disclosed herein are provided below. An embodiment of the technologies may include any one or more, and any combination of, the examples described below.

Example 1 includes a compute device comprising a redirector device to receive, from an initiator device, a request that identifies a data set to be accessed; determine, from a set of routing rules indicative of target devices associated with data sets, whether the identified data set is available in a storage server associated with the present redirector device; forward, in response to a determination that the identified data set is not available in a storage server associated with the present redirector device, the request to a target device associated with the data set in the routing rules; and send, to the initiator device, an identification of the target device associated with the data set in the routing rules.

Example 2 includes the subject matter of Example 1, and wherein the redirector device is further to receive, from the target device, an identification of a different target device to which data requests associated with the identified data set are to be sent; and store the identification of the different target device in the routing rules.

Example 3 includes the subject matter of any of Examples 1 and 2, and wherein the redirector device is further to send, to the initiator device, the identification of the different target device.

Example 4 includes the subject matter of any of Examples 1-3, and wherein the redirector device is further to receive, from a manager server, default routing rules indicative of predefined target devices to which data access requests are to be sent.

Example 5 includes the subject matter of any of Examples 1-4, and wherein to determine, from a set of routing rules indicative of target devices associated with data sets, whether the identified data set is available in a storage server associated with the present redirector device further comprises to select a routing rule from a plurality of routing rules as a function of a specificity of each routing rule associated with the identified data set.

Example 6 includes the subject matter of any of Examples 1-5, and wherein to receive, from an initiator device, a request that identifies a data set comprises to receive the request from another redirector device.

Example 7 includes the subject matter of any of Examples 1-6, and wherein the redirector device is further to receive data that indicates that a data set that was previously located at a storage server associated with the present redirector device has moved to a different storage server.

Example 8 includes the subject matter of any of Examples 1-7, and wherein the redirector device is further to receive data that indicates that a data set that was previously located at one storage server has been moved to a second storage server, wherein the second storage server is associated with the present redirector device.

Example 9 includes the subject matter of any of Examples 1-8, and wherein to determine, from a set of routing rules indicative of target devices associated with data sets, whether the identified data set is available in a storage server associated with the present redirector device further comprises to match a compute server that initiated the request with one of multiple target devices identified in the routing rules.

Example 10 includes the subject matter of any of Examples 1-9, and wherein to receive, from an initiator device, a request that identifies a data set to be accessed comprises to receive a request to write to the identified data set; and the redirector device is further to forward the request to multiple target devices associated with replicas of the data set.

Example 11 includes the subject matter of any of Examples 1-10, and wherein to receive a request that identifies a data set to be accessed comprises to receive a request to access a logical block address.

Example 12 includes the subject matter of any of Examples 1-11, and wherein to receive a request that identifies a data set to be accessed comprises to receive a request to access an extent of a volume.

Example 13 includes one or more machine-readable storage media comprising a plurality of instructions stored thereon that, in response to being executed, cause a redirector device to receive, from an initiator device, a request that identifies a data set to be accessed; determine, from a set of routing rules indicative of target devices associated with data sets, whether the identified data set is available in a storage server associated with the present redirector device; forward, in response to a determination that the identified data set is not available in a storage server associated with the present redirector device, the request to a target device associated with the data set in the routing rules; and send, to the initiator device, an identification of the target device associated with the data set in the routing rules.

Example 14 includes the subject matter of Example 13, and wherein the plurality of instructions, when executed, further cause the redirector device to receive, from the target device, an identification of a different target device to which data requests associated with the identified data set are to be sent; and store the identification of the different target device in the routing rules.

Example 15 includes the subject matter of any of Examples 13 and 14, and wherein the plurality of instructions, when executed, further cause the redirector device to send, to the initiator device, the identification of the different target device.

Example 16 includes the subject matter of any of Examples 13-15, and wherein the plurality of instructions, when executed, further cause the redirector device to receive, from a manager server, default routing rules indicative of predefined target devices to which data access requests are to be sent.

Example 17 includes the subject matter of any of Examples 13-16, and wherein to determine, from a set of routing rules indicative of target devices associated with data sets, whether the identified data set is available in a storage server associated with the present redirector device further comprises to select a routing rule from a plurality of routing rules as a function of a specificity of each routing rule associated with the identified data set.

Example 18 includes a method comprising receiving, by a redirector device and from an initiator device, a request that identifies a data set to be accessed; determining, by the redirector device and from a set of routing rules indicative of target devices associated with data sets, whether the identified data set is available in a storage server associated with the present redirector device; forwarding, by the redirector device and in response to a determination that the identified data set is not available in a storage server associated with the present redirector device, the request to a target device associated with the data set in the routing rules; and sending, by the redirector device and to the initiator device, an identification of the target device associated with the data set in the routing rules.

Example 19 includes the subject matter of Example 18, and further including receiving, by the redirector device and from the target device, an identification of a different target device to which data requests associated with the identified data set are to be sent; and storing, by the redirector device, the identification of the different target device in the routing rules.

Example 20 includes the subject matter of any of Examples 18 and 19, and further including sending, by the redirector device and to the initiator device, the identification of the different target device.

1. A compute device comprising:
a redirector device to:
receive, from an initiator device, a request that identifies a data set to be accessed;
determine, from a set of routing rules indicative of target devices associated with data sets, whether the identified data set is available in a storage server associated with the present redirector device;
forward, in response to a determination that the identified data set is not available in a storage server associated with the present redirector device, the request to a target device associated with the data set in the routing rules; and
send, to the initiator device, an identification of the target device associated with the data set in the routing rules.

2. The compute device of claim 1, wherein the redirector device is further to:
receive, from the target device, an identification of a different target device to which data requests associated with the identified data set are to be sent; and
store the identification of the different target device in the routing rules.

3. The compute device of claim 2, wherein the redirector device is further to send, to the initiator device, the identification of the different target device.

4. The compute device of claim 1, wherein the redirector device is further to receive, from a manager server, default routing rules indicative of predefined target devices to which data access requests are to be sent.

5. The compute device of claim 1, wherein to determine, from a set of routing rules indicative of target devices associated with data sets, whether the identified data set is available in a storage server associated with the present redirector device further comprises to select a routing rule from a plurality of routing rules as a function of a specificity of each routing rule associated with the identified data set.

6. The compute device of claim 1, wherein to receive, from an initiator device, a request that identifies a data set comprises to receive the request from another redirector device.

7. The compute device of claim 1, wherein the redirector device is further to receive data that indicates that a data set that was previously located at a storage server associated with the present redirector device has moved to a different storage server.

8. The compute device of claim 1, wherein the redirector device is further to receive data that indicates that a data set that was previously located at one storage server has been moved to a second storage server, wherein the second storage server is associated with the present redirector device.

9. The compute device of claim 1, wherein to determine, from a set of routing rules indicative of target devices associated with data sets, whether the identified data set is available in a storage server associated with the present redirector device further comprises to match a compute server that initiated the request with one of multiple target devices identified in the routing rules.

10. The compute device of claim 1, wherein to receive, from an initiator device, a request that identifies a data set to be accessed comprises to receive a request to write to the identified data set; and
the redirector device is further to forward the request to multiple target devices associated with replicas of the data set.

11. The compute device of claim 1, wherein to receive a request that identifies a data set to be accessed comprises to receive a request to access a logical block address.

12. The compute device of claim 1, wherein to receive a request that identifies a data set to be accessed comprises to receive a request to access an extent of a volume.

13. One or more machine-readable storage media comprising a plurality of instructions stored thereon that, in response to being executed, cause a redirector device to:
receive, from an initiator device, a request that identifies a data set to be accessed;
determine, from a set of routing rules indicative of target devices associated with data sets, whether the identified data set is available in a storage server associated with the present redirector device;
forward, in response to a determination that the identified data set is not available in a storage server associated with the present redirector device, the request to a target device associated with the data set in the routing rules; and
send, to the initiator device, an identification of the target device associated with the data set in the routing rules.

14. The one or more machine-readable storage media of claim 13, wherein the plurality of instructions, when executed, further cause the redirector device to:
receive, from the target device, an identification of a different target device to which data requests associated with the identified data set are to be sent; and
store the identification of the different target device in the routing rules.

15. The one or more machine-readable storage media of claim 14, wherein the plurality of instructions, when executed, further cause the redirector device to send, to the initiator device, the identification of the different target device.

16. The one or more machine-readable storage media of claim 13, wherein the plurality of instructions, when executed, further cause the redirector device to receive, from a manager server, default routing rules indicative of predefined target devices to which data access requests are to be sent.

17. The compute device of claim 1, wherein to determine, from a set of routing rules indicative of target devices associated with data sets, whether the identified data set is available in a storage server associated with the present redirector device further comprises to select a routing rule from a plurality of routing rules as a function of a specificity of each routing rule associated with the identified data set.

18. A method comprising:
receiving, by a redirector device and from an initiator device, a request that identifies a data set to be accessed;
determining, by the redirector device and from a set of routing rules indicative of target devices associated with data sets, whether the identified data set is available in a storage server associated with the present redirector device;
forwarding, by the redirector device and in response to a determination that the identified data set is not available in a storage server associated with the present redirector device, the request to a target device associated with the data set in the routing rules; and
sending, by the redirector device and to the initiator device, an identification of the target device associated with the data set in the routing rules.

19. The method of claim 18, further comprising:
receiving, by the redirector device and from the target device, an identification of a different target device to which data requests associated with the identified data set are to be sent; and
storing, by the redirector device, the identification of the different target device in the routing rules.

20. The method of claim 19, further comprising sending, by the redirector device and to the initiator device, the identification of the different target device.
